(19) United States
(12) Patent Application Publication
(10) Pub. No.: US 2026/0310766 A1
(43) Pub. Date: Oct. 8, 2026

(54) USER AUTHENTICATION IN COMPUTER DEVICES THROUGH STATISTICAL ANALYSIS OF GESTURE DATA

(71) Applicant: Dell Products L.P., Round Rock, TX (US)

(72) Inventors: Tejinder Singh, Manotick (CA); Navjot Kaur Khaira, Manotick (CA); Kan Wang, Ottawa (CA); Ibrahim Abu Alhaol, Nepean (CA)

(21) Appl. No.: 19/170,829

(22) Filed: Apr. 4, 2025

(51) Int. Cl. G06F 21/32

(52) U.S. Cl. CPC G06F 21/32

(57) ABSTRACT

The technology described herein is directed towards using a wearable passive metasurface (e.g., configured as a ring) to reflect signals representative of user interaction with computer peripheral devices (e.g., a mouse and keyboard) coupled to a computing device. The reflected signals indicate current user interaction with the device obtained over a timeframe. A trained model set processes statistical features of the user interaction patterns, extracted from the current interaction pattern data, to detect any threshold deviation from a prior authorized user's interaction profile data, based on the authorized user's statistically typical interaction behavior on which the model was trained. Any significant deviation indicates a possibly different user. Based on the statistical user interaction pattern data, the model outputs authentication response data, such as authorized or not, or confidence level data, for comparison with a confidence level threshold, to determine whether the user is an authorized user of the computing device.

### RELATED APPLICATIONS

The subject patent application is related to U.S. patent application Ser. No. 19/030,562, filed Jan. 17, 2025, and entitled “UTILIZING PASSIVE WEARABLE DEVICES TO CAPTURE DEVICE INTERACTION DATA FOR SUPPLEMENTARY AUTHENTICATION” (docket no. 140405.01/DELLP1426US), and U.S. patent application Ser. No. 19/056,466, filed Feb. 18, 2025, and entitled “LONG-TERM PATTERN RECOGNITION USING PROXIMITY DETECTION FOR SECURITY APPLICATIONS” (docket no. 140401.01/DELLP1448US), the entireties of which patent applications are hereby incorporated by reference herein.

### BACKGROUND

Existing wearable devices (e.g., rings) focus on health and activity monitoring. Such wearable devices rely on establishing a BLUETOOTH communication link with a computing device, such as a personal computer or cellphone. These wearable devices tend to be heavy and thick due to the inclusion of sensors and other components, and in general are expensive because of high manufacturing costs.

### BRIEF DESCRIPTION OF THE DRAWINGS

The technology described herein is illustrated by way of example and not limited in the accompanying figures in which like reference numerals indicate similar elements and in which:

FIG. 1A is a block diagram representation of an example wearable device including a passive metasurface communicating with a computing device via a transceiver embedded in a computer peripheral device, in accordance with various example embodiments and implementations of the subject disclosure.

FIG. 1B is a representation of example computer peripheral devices (keyboard and/or mouse) that can include or be coupled to a transceiver for communicating with a metasurface, in accordance with various example embodiments and implementations of the subject disclosure.

FIG. 2 is a representation of an example wearable device in the form of a ring design, in which the wearable device detects user interaction activity data with a keyboard and/or mouse, in accordance with various example embodiments and implementations of the subject disclosure.

FIG. 3 is an example representation of a pattern of detected user interaction data acquired within a time window, in accordance with various example embodiments and implementations of the subject disclosure.

FIG. 4 is an example representation of another (relative to FIG. 3) pattern of detected user interaction data acquired within a time window, in accordance with various example embodiments and implementations of the subject disclosure.

FIG. 5 is an example representation of a Gaussian distribution of user behavior data, such as to establish a baseline interaction profile for a user, in accordance with various example embodiments and implementations of the subject disclosure.

FIG. 6 is a representation of user authentication for security purposes based on implied user interaction behavior pattern data obtained from gestures during user interaction with a device, and without explicit user authentication input, in accordance with various example embodiments and implementations of the subject disclosure.

FIGS. 7 and 8 comprise a flow diagram showing example operations related to obtaining user interaction pattern data reflected from a wearable metasurface to determine, based on a distribution pattern associated with the user interaction patten data, whether the user is an authorized user of a computing device, in accordance with various example embodiments and implementations of the subject disclosure.

FIG. 9 is a flow diagram showing example operations related to obtaining current user interaction pattern data reflected from a wearable metasurface and processing the data into Gaussian distribution pattern data to ascertain whether the user is an authorized user of a computing device, in accordance with various example embodiments and implementations of the subject disclosure.

FIG. 10 is a flow diagram showing example operations related to monitoring interaction with a computing device to perform ongoing authentication of a user, based on a trained model set determining from Gaussian distribution data corresponding to user interaction pattern data whether the is user authorized to use the computing device, in accordance with various example embodiments and implementations of the subject disclosure.

### DETAILED DESCRIPTION

The technology described herein is generally directed towards detecting user interaction with computer peripheral devices (e.g., a mouse and keyboard) coupled to a computing device, via a wearable metasurface, such as in the form of a ring, that reflects transmitted signals to the computing device. The reflected signals, during times of user interaction with a computer peripheral device/the computing device, provide current user interaction pattern data (user activity profile data/gesture data) that facilitate the non-intrusive evaluation of current user interaction data. The current user interaction pattern data is processed into (e.g., Gaussian) distribution pattern data to evaluate whether features of the data match prior interaction pattern data of an authorized user of the computing device. A trained model set (e.g., one or more artificial intelligence (AI) models), trained based on the prior interaction pattern data of the authorized user, can perform the evaluation and decide whether the user interaction gestures are those of the authorized user, or are possibly a nonauthorized user.

The decision whether the current user is an authorized user can be a binary decision, or can be in the form of confidence level data based on how well the user's current behavior data, processed into Gaussian distribution pattern data including feature data, aligns with prior user interaction data of the authorized user, which can be used to train the model, A decision whether to authorize access, or authorize continued usage of the computing device during ongoing monitoring, can be made based on whether the returned confidence level data satisfies defined threshold confidence level data set for authentication.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in RF communications and RF devices in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

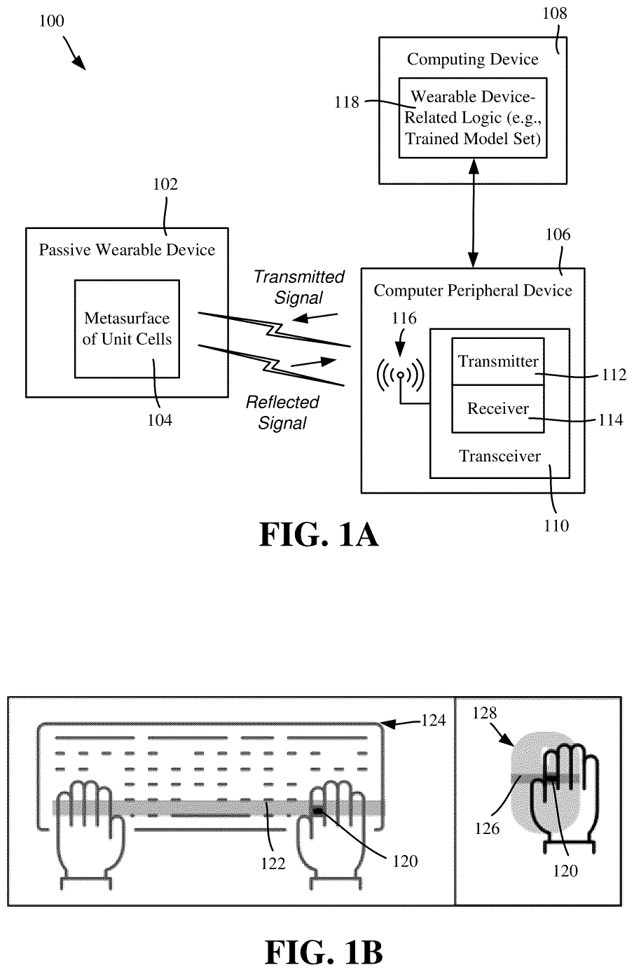

FIG. 1A is a block diagram representation of one example implementation of a system 100 in which a wearable device 102, which includes a metasurface of unit cells 104, communicates with a computer peripheral (device) 106 coupled to a computing device 108. In the example of FIG. 1A, the computer peripheral device 106 includes an embedded, integrated or otherwise internal transceiver 110, which in turn includes a transmitter 112 and receiver 114. The transceiver components are coupled to an antenna 116 that transmits signals to the metasurface 104 of the passive wearable device 102, which as described herein, alters a redirected instance of the signal's characteristics reflected to the transceiver's receiver 114. Based on the received signal, wearable device-related logic 118 (e.g., a hardware or software program running in the computing device 108, such as a trained AI model or set of models) can analyze the reflected signal and take some action based thereon as described herein, such as to wake the operating system program or the like for execution in the computing device, or to take a security-related action is an authorized user is not detected, e.g., output an alert, or request that the user verify a user identity via traditional methods like password or PIN entry, or a biometric scan.

Although typically the computer device 118 is an AI-enabled computer device capable of running the trained model(s), it is alternatively feasible for the computer peripheral device 106 to include the wearable device-related logic 118, or the wearable device-related logic 118 can be divided between the computer peripheral device 106 and the computing device 108. It is also alternatively feasible for the computing device to include the transceiver, as long as the reflected signals that result from user interaction can be detected; this is likely in a situation in which a laptop computer or the like incorporates the pointing device and keyboard.

Still further, the transmitter can be separate from the receiver, e.g., a transmitter that outputs signals to multiple users having wearable metasurfaces, with each metasurface reflecting into a specific receiver associated with a specific computing device. Indeed, while a dedicated transceiver is one practical and convenient example, it should be noted that the transmitter and the receiver can be separate components. For example, consider an office setting where a single wall-mounted transmitter can transmit signals to multiple user work locations. Each user can share the same transmitter, yet have his or her own passive wearable device that reflects from the transmitter to a receiver. The users' respective computing devices can have respective external or internal receivers.

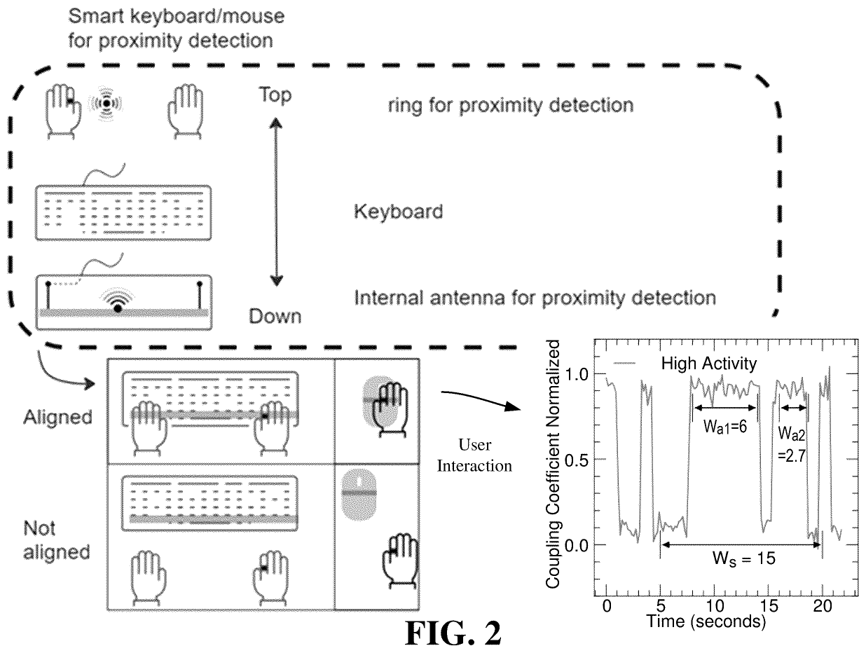

FIGS. 1B and 2 show the general concept of a wearable ring 120 with a metasurface interacting with a peripheral device 124 or 128. The ring-based wearable metasurface 120 can act as a key to lock and unlock a computer, for example, or at least detect the user's presence to wake the computer, such as to automatically open present an interactive lock screen when proximity is detected. Ongoing monitoring can take place to regularly or occasionally detect whether the current user wearing the wearable metasurface 120 is still the authorized user, e.g., to check that someone else did not obtain the wearable metasurface 120 while the authorized user was away from the device.

More particularly, FIG. 1B shows the concept of an example ring 120 with a metasurface that couples to a transceiver/antenna 122 incorporated into a keyboard 124. Alternatively, or in addition to the transceiver/antenna 122 incorporated into the keyboard 124, a transceiver/antenna 126 can be incorporated into a mouse 128 or other pointing device.

FIG. 2 shows ways in which the transceiver (with antennas) can be embedded into computing device peripherals like a keyboard and a mouse. For users wearing a metasurface on a ring, hand movements, key presses, and mouse actions can be captured, for model training and subsequent analysis, e.g., for authentication. The transceiver's antenna sends monitoring signals, which are reflected by the metasurface on the ring and registered by the system. The transceiver can be designed to be a native part of the device peripherals, ensuring seamless interaction and monitoring.

To summarize, the operation is based on having a receiver coupled to or incorporated into a computing device, e.g., as a native part of the computing device, or as an auxiliary USB or added card coupled to the computing device. A transmitter, which can be a transceiver that also receives the signal, transmits a wireless scanning signal, which in the presence of the metasurface is reflected back to the receiver, whereby the presence of the metasurface (and thus the user wearing the metasurface) is detected, as well as the user interaction pattern data. In one implementation, the use of sub-terahertz range communication ensures that the metasurface remains compact, and that the system only detects the metasurface when the metasurface is in close proximity to the computing device, preventing unauthorized access from a distance. The wearable metasurface ring thus has the potential to act as a replacement or provide additional security for existing user authentication processes and as an aid to enhance current systems, e.g., offering a seamless and secure method for authentication that can be more convenient and less obtrusive than traditional methods like passwords, PINs, or biometric scans.

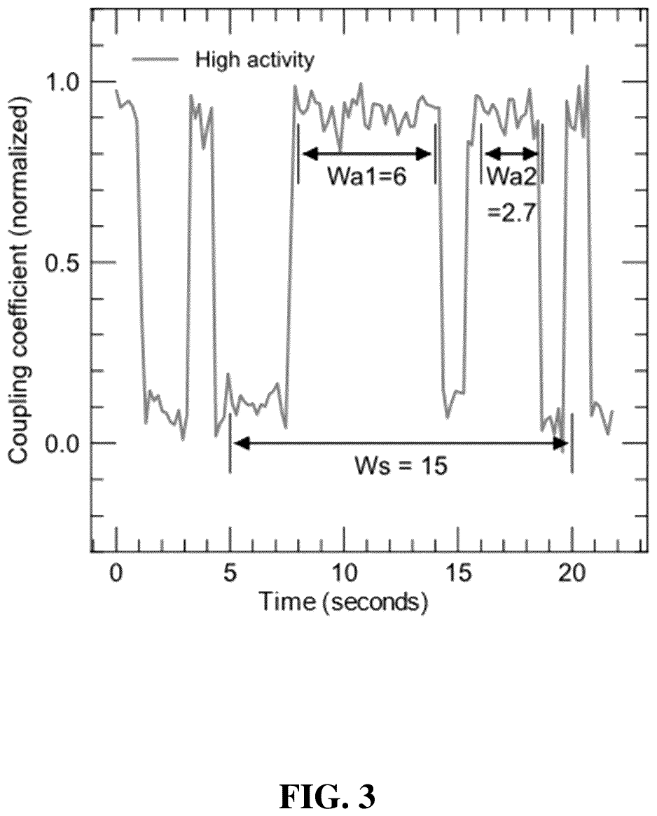

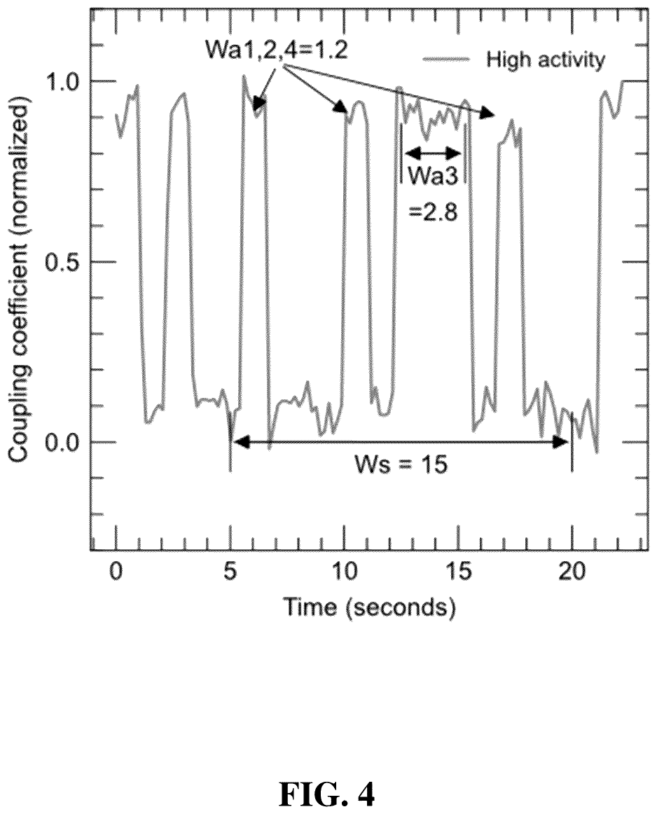

FIGS. 3 and 4 are graphical representations of user interactions with a computing device via a peripheral, in which the metasurface reflects signals based on how the user is interacting within a time window Ws, which are fifteen seconds each (from five seconds to twenty seconds) in the two graphical examples. The coupling coefficient normalized from approximately zero to one indicates times of low activity, having the coupling coefficient value near zero, and high activity, having the coupling coefficient value near one. FIGS. 3 and 4 can be samples from different users, or can be different sample instances obtained at different times from the same user, possibly from different peripheral devices.

As can be seen in FIGS. 3 and 4, there are different interaction patterns corresponding to how the same user at different times was interacting with a peripheral device, or how two different users were interacting with their respective peripheral devices. For example, FIG. 3 shows interaction pattern data having two times of high interaction activity such as keyboard typing (the smaller time windows Wa1 and Wa2) within the fifteen second time window Ws, of Wa1=6.0 seconds and Wa2 equals 2.7 seconds. FIG. 4 shows interaction pattern data with four times of high interaction activity (smaller time windows) (Wa1, Wa2, Wa3 and Wa4) within its similar fifteen second time window Ws, of Wa1=Wa2=Wa4=1.2 seconds each, and Wa3=2.8 seconds. Note that the same type of peripheral device such as a keyboard will have different interaction patterns from another peripheral device such as a mouse, and thus multiple types of datasets can be gathered per user, for model training and later inference.

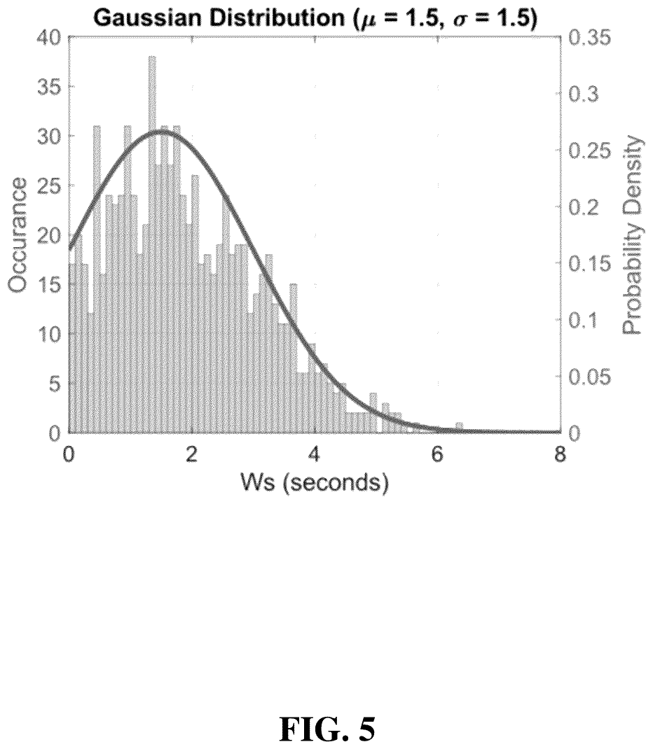

FIG. 5 shows the general concept of user authentication in AI-capable computing devices by statistical analysis of the user interaction pattern data. By collecting user behavior data in short spans (e.g., 15-25 seconds) using a metasurface, e.g., on a ring, the system can extract features such as active time span, total active time, and the number of active times. Such features can be analyzed using Gaussian or similar distributions as shown in FIG. 5 to calculate the resulting mean and standard deviation, providing a comprehensive understanding of user interaction patterns.

In the example of a ring-based metasurface, the system extracts the user interaction pattern data acquired from the proximity detection device as shown in FIGS. 3 and 4, e.g., of an overall timing window (e.g., 25 seconds) that includes the Ws timing window. The features such as active time spans Wa, total active time (active times summed) and number of active times (e.g., two in FIG. 3 and four in FIG. 4) can be extracted. Thus, from an evaluation of the captured interaction pattern data, a current user's active time span, total active time, and number of times the user goes active are determined.

During model training, after capturing a sufficient number of samples, a baseline profiling technique is used, which in one implementation involves establishing baseline profile data for user behavior using Gaussian distribution. This allows for a clear and quantifiable understanding of typical user patterns, providing a foundation for accurate user authentication.

The determination of the mean and standard deviation enables a trained model set to quantify deviations from normal behavior. Such a statistical process ensures that only significant deviations (e.g., relative to a defined threshold deviation) trigger additional authentication, reducing false positives and enhancing security. Note further that in conjunction with, or as a supplement to, the statistical analysis of the user interaction pattern data as described herein, one or more other types of analyses can be done, e.g., time analysis and frequency analysis on captured interaction pattern data in the time domain spectrum and frequency domain spectrum, which can help more conclusively determine whether the user can be authenticated or not via the user interaction activity.

As can be seen in FIG. 5, in one implementation the statistical analysis is based on plotting these features, fitting Gaussian distributions, and establishing baseline profiles for each user, e.g., one or more authorized users per computing device. Comparing current user interaction pattern data, such as shown in FIGS. 3 and 4, to the baseline profile data for a current user allows the system to continuously and non-intrusively authenticate authorized users. Significant deviations from the baseline indicate that the system is unable to determine from the current interaction pattern data whether the current user is an authorized user, which can trigger additional authentication steps, ensuring robust protection against unauthorized access. Such a dynamic approach enhances security by providing ongoing monitoring and verification instead of relying on initial one-time checks.

The following table, TABLE 1, shows extraction of distribution data for user interaction pattern data using a Ws pulse sample number on the order of 1000:

TABLE 1

| Batch | | | | | | Authorized |
|---|---|---|---|---|---|---|
| index | # of Wa | Sum of Wa | σ of Ws | μ of Ws | . . . | user (1/0) |
| 1 | 1000 | 8.7 | 1.5 | 1.5 | . . . | 1 |
| 2 | 950 | 6.4 | 3 | 2 | . . . | 0 |
| 3 | 800 | 8.9 | 1.3 | 2 | . . . | 1 |
| . . . | . . . | . . . | . . . | . . . | . . . | . . . |

The example resulting feature set is similarly extracted from the acquired data, where the first column corresponds to similar plots in FIGS. 3-5. The rightmost column shows a label for training and evaluation, where ‘1’ indicates an authorized user and ‘0’ indicates an unauthorized user.

As is understood, once trained, the trained model set can obtain the same set of features as input for a current user, and output a binary yes/no decision as to whether the user is an authorized user (1), or is an unauthorized user (0) (at least) with respect to the inability of the trained model to authenticate the current user. This “unauthorized user” conclusion that is output by the trained model is not definitive proof that the user is not the authorized user, only that the interaction pattern data did not sufficiently match the user profile data for an authorized user, and indeed, one or more additional verification steps can be taken to authenticate the user, such as via conventional means such as password/PIN entry, multifactor authentication, and/or biometric identification.

To summarize thus far, described herein is user authentication in the AI capable computing devices by statistical analysis of user interaction data. Now by collecting user behavior in a short time span example using a metasurface deployed for example on a “smart ring,” a feature dataset is extracted based on the active times in which the computing device or peripheral can detect the peaks of activity indicative of user interaction (e.g., typing on a keyboard/moving a mouse). The feature dataset is analyzed using a Gaussian distribution (indicating occurrence and probability density), including to calculate the mean and standard deviation. Current user data can be evaluated against a baseline profile for an authorized user using this distribution.

Tracking data also can be obtained for analytics, e.g., whether the user is actually using the keyboard and mouse as frequently as others tend to do, rather than just occasionally moving his or her mouse. The user may not be interacting because of attending a meeting a passive participant or observing a training video, but such data can also be captured for analytics, along with another set of data based on proximity detection.

Thus, a given user has certain typing patterns/pointing device interactions depending on the way he or she uses their computing device. After (e.g., a few days or so of) sufficient device interaction, a signature profile can be obtained and assigned to that user based on the user's interaction with the input devices. If someone else who is not authorized subsequently obtains the metasurface (e.g., takes the ring), gets close to the computer and uses the input devices, the new current user (the impersonator) will not be authenticated during ongoing monitoring based on the authorized user's prior patterns of activity.

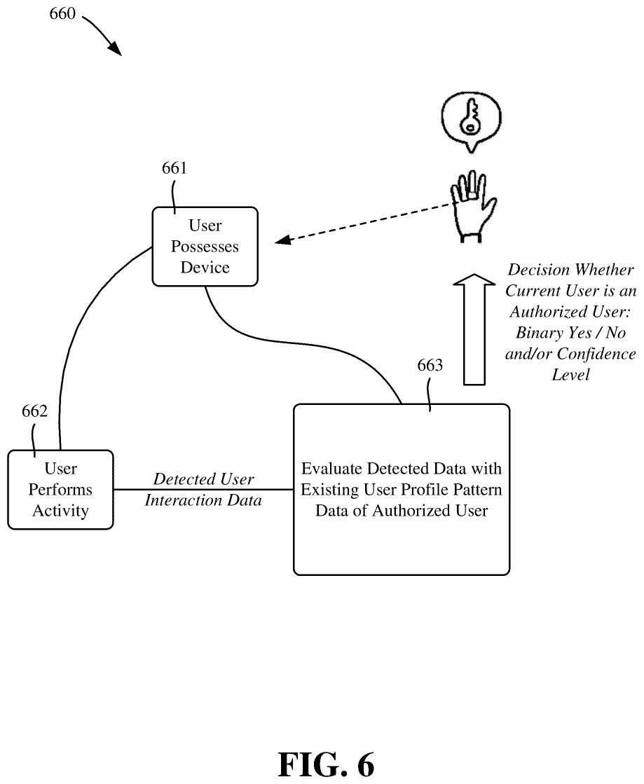

FIG. 6 generally represents a multi-factor authentication framework 660 based on three example elements, or factors. Each factor represents a different component of user authentication, contributing to a robust security system. More particularly, a first factor (represented in FIG. 6 by block 661) is based on possession of a manufactured ring or other a passive wearable metasurface, such as one that can have a unique signature, e.g., the unit cells of one such metasurface are fabricated to reflect signals with characteristics that are detectably distinct from the reflected signals of any other metasurface. In this example, the ring serves as a physical token that the user has to possess to authenticate his or her identity. The metasurface/ring is thus an external object that is specifically designed and linked to the authorized user, making possession of the device a first element in verifying the user's identity.

A second factor (represented by block 662) involves detecting the user's current activity, such as typing, moving a mouse, or other behavior patterns. The system monitors and differentiates between types of activity, and then captures the corresponding user interaction pattern data. The system recognizes that the way a person interacts with the environment, such as by typing rhythm or movement patterns, can be unique and indicative of their identity.

A third factor (represented by block 663) pertains to the previously obtained knowledge of the statistical behavior of the authorized use, that is, the user profile pattern data. The system has learned features based on the user's previous behaviors with respect to the current type of activity, and uses this knowledge to authenticate the user. By comparing feature data of the current activity with the known profile data of a user, via a trained model set, the system can determine whether the current interaction behavior is likely that of an authorized user of the computing device.

In one implementation, the trained model set outputs authentication response data in the form of a binary yes or no decision. In an alternative implementation, the trained model set outputs confidence level data, which can be evaluated by another part of the system to determine whether the returned confidence level data satisfies defined confidence level threshold data. Note that the defined threshold confidence level data can be determined based on external conditions or other factors, e.g., a lower threshold can be set if the user is known to be interacting with the computing device at a home location, versus interacting at a public location, where a higher confidence level is needed for higher security.

Together, having possession of the device, performing specific activities, and recognizing that the current interaction pattern data statistically aligns well with prior (known) interaction profile data maintained for the user, create a layered and secure authentication system. The framework 660 thus operates to ensure that the user is authenticated not only by what they possess (the ring), but also by what the user is currently doing, and what the system knows about an authorized user's behavior, making it difficult for unauthorized users to gain access.

An AI learning engine can combine user behavior patterns with contextual factors like location, with can be used to dynamically adjust a security confidence level. For instance, the security confidence level with respect to sensed interaction pattern is higher at a user's home location (and thus can have a lower defined threshold level to satisfy), and lower in a public space like a cafeteria (and thus can have a higher defined threshold level to satisfy). This dynamic and personalized approach strengthens security protocols within a zero-trust framework, while adapting to individual behavior and environmental context in a non-intrusive manner, thereby enhancing the overall user experience. In general, security in terms of authentication and usability is enriched with the integration of intelligent and responsive peripherals and their associated computing devices.

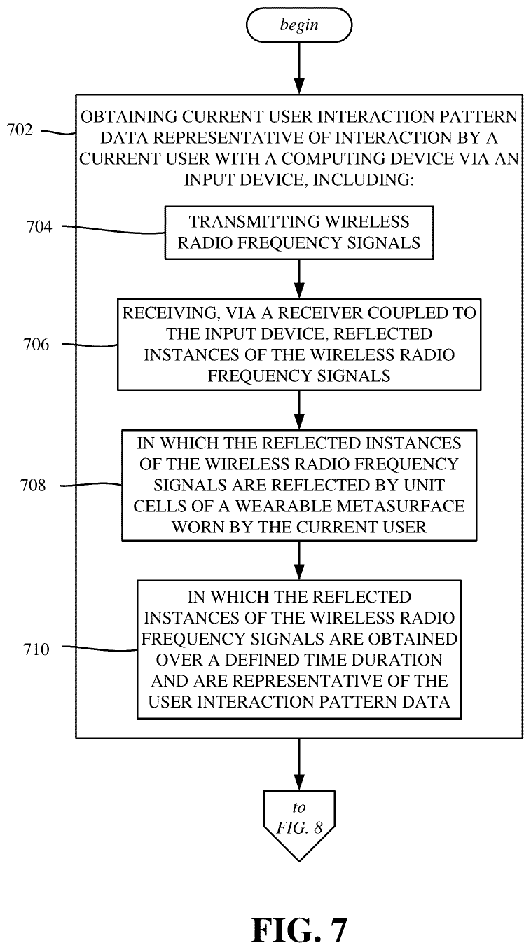

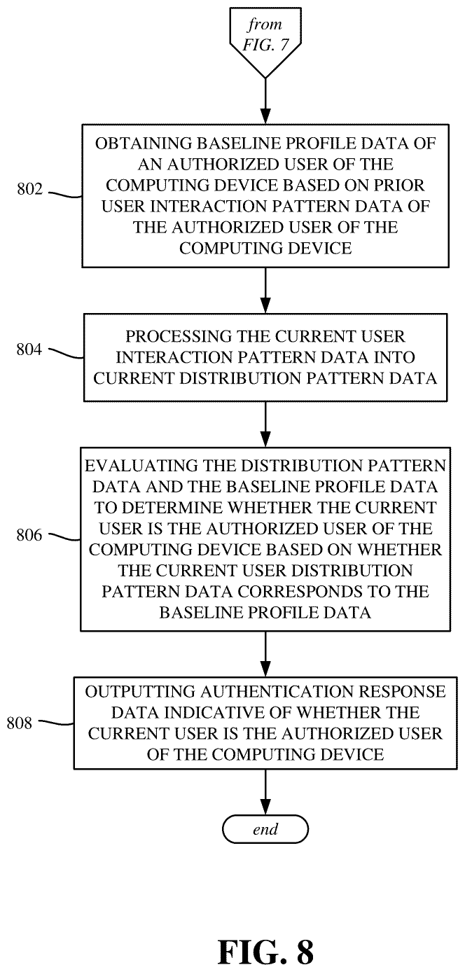

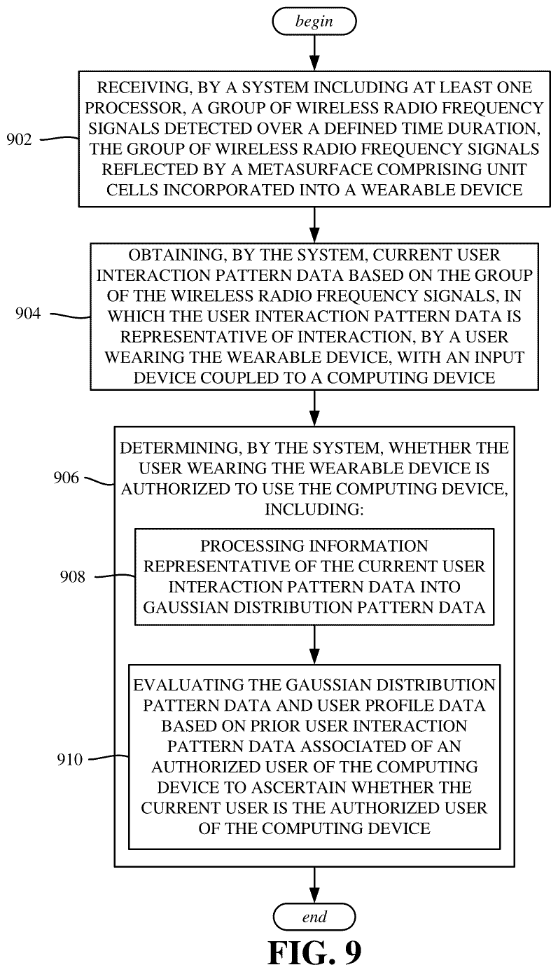

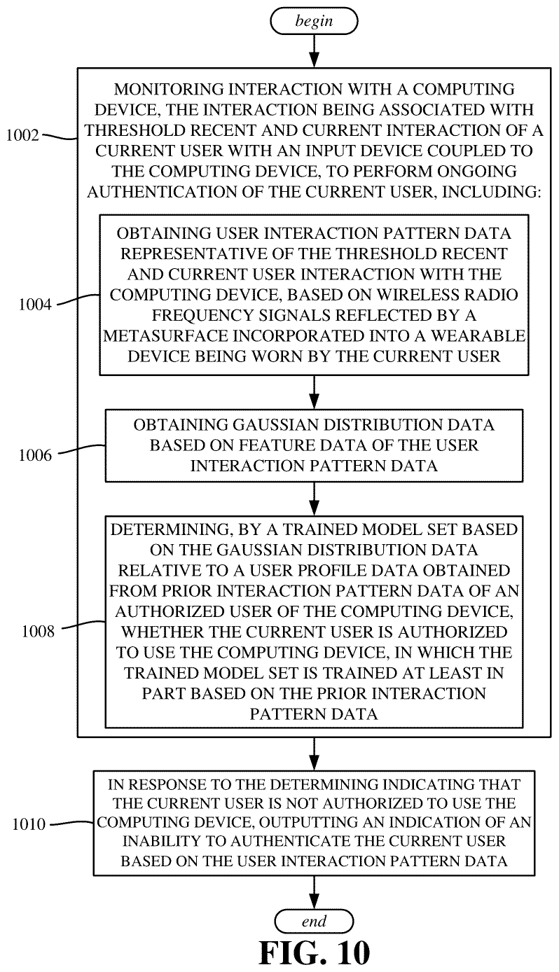

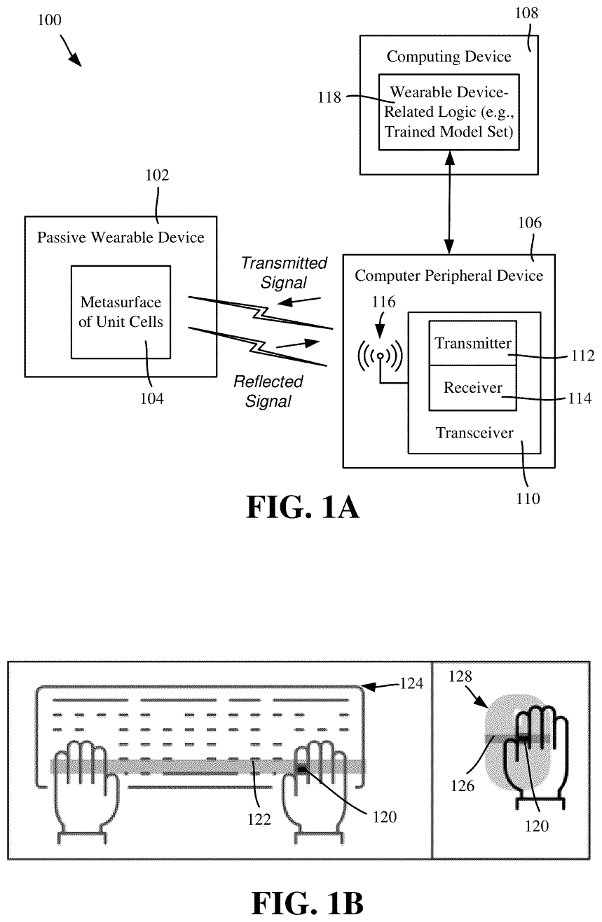

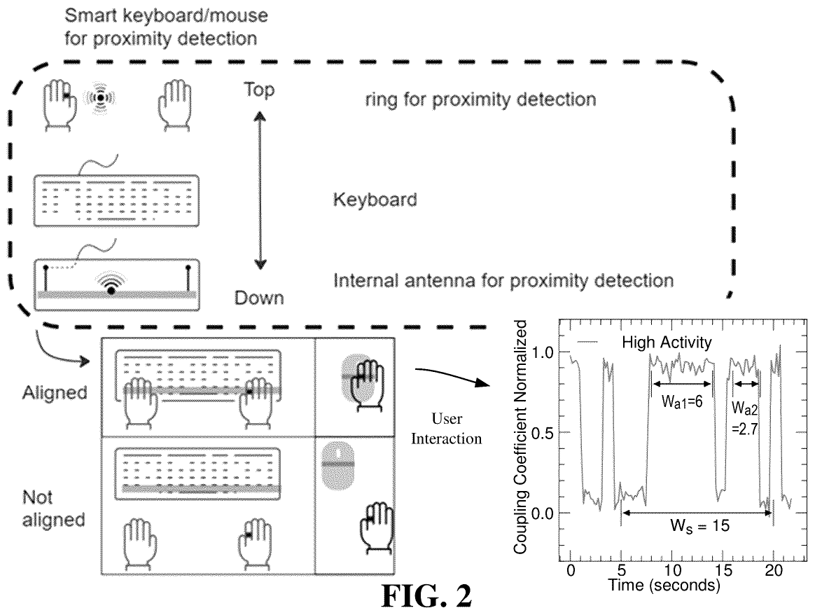

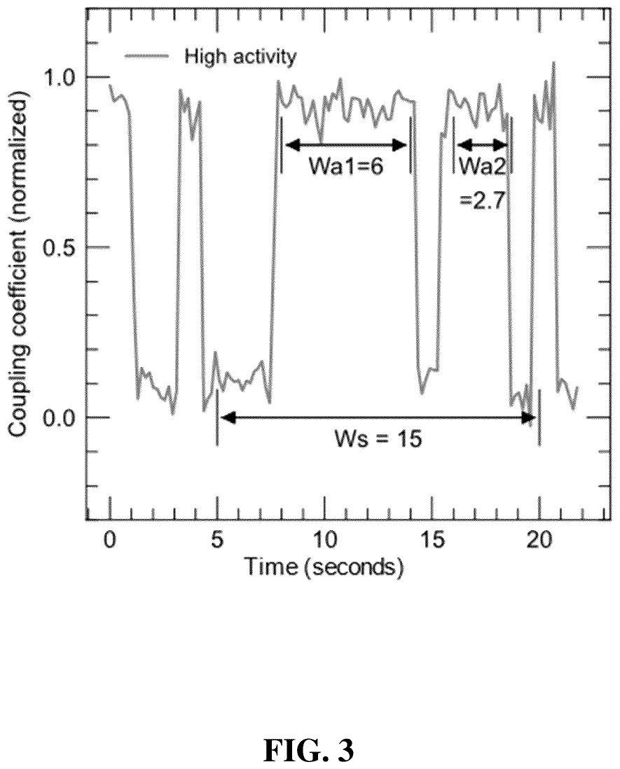

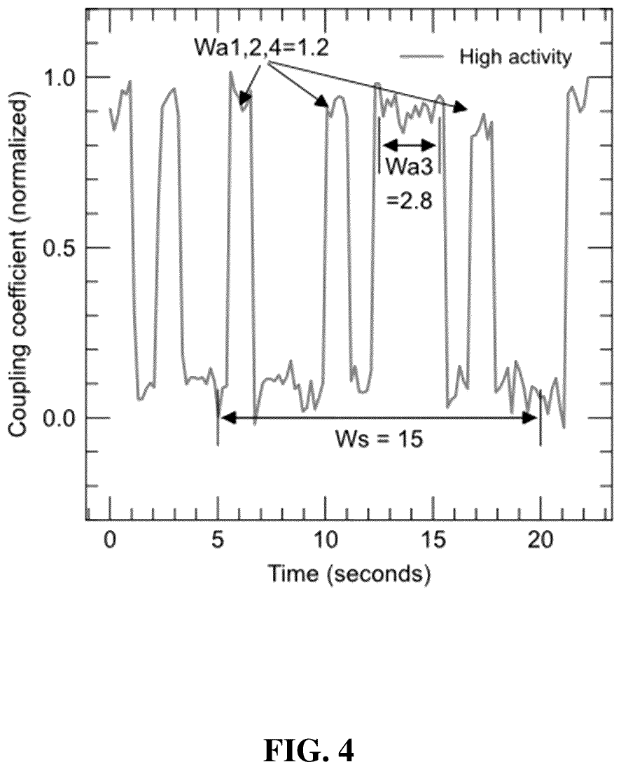

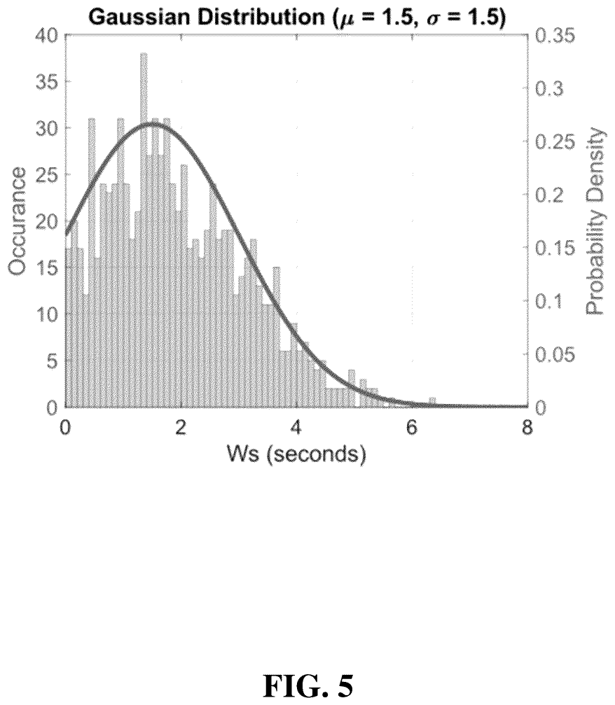

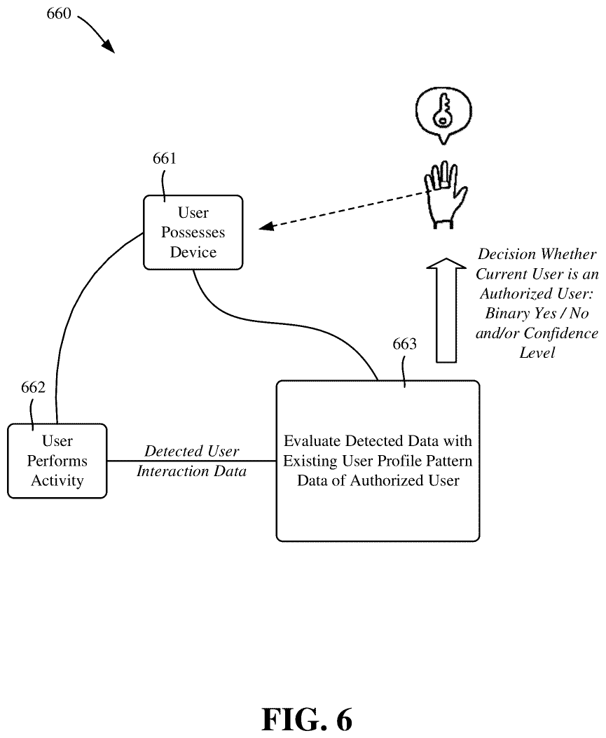

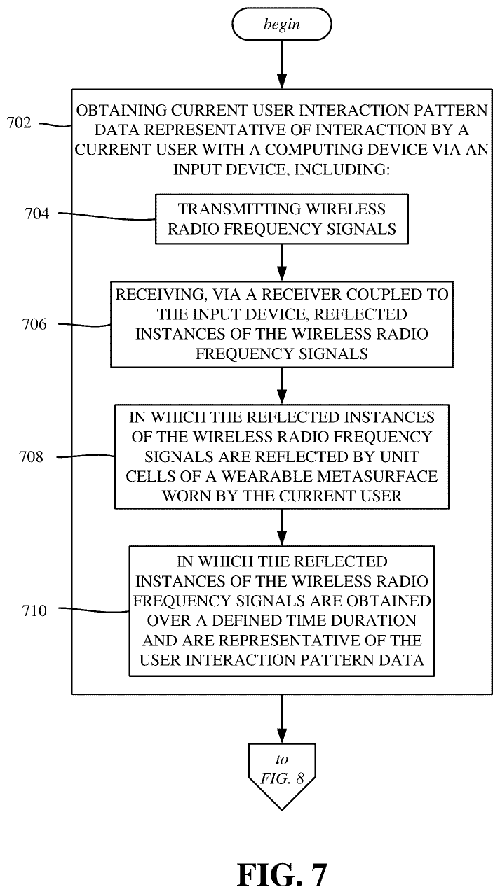

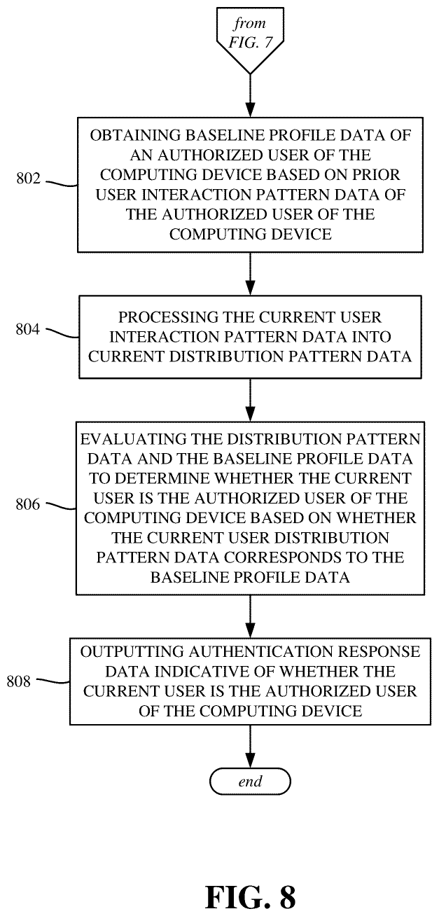

One or more implementations can be embodied in a system, such as represented in the example operations of FIGS. 7 and 8, and for example can include at least one processor memory that stores computer executable components and/or operations, and at least one processor that executes computer executable components and/or operations stored in the memory. Example operations can include operation 702 of FIG. 7, which represents obtaining current user interaction pattern data representative of interaction by a current user with a computing device via an input device; Example operation 702 includes example operations 704, 706, 708 and 710. Example operation 704 represents transmitting wireless radio frequency signals. Example operation 706 represents receiving, via a receiver coupled to the input device, reflected instances of the wireless radio frequency signals. Example block 708 represents that the reflected instances of the wireless radio frequency signals are reflected by unit cells of a wearable metasurface worn by the current user. Example block 710 represents that the reflected instances of the wireless radio frequency signals are obtained over a defined time duration and are representative of the user interaction pattern data. The example operations continue to FIG. 8, where Example operation 702 represents obtaining baseline profile data of an authorized user of the computing device based on prior user interaction pattern data of the authorized user of the computing device. Example operation 804 represents processing the current user interaction pattern data into current distribution pattern data. Example operation 806 represents evaluating the distribution pattern data and the baseline profile data to determine whether the current user is the authorized user of the computing device based on whether the current user distribution pattern data corresponds to the baseline profile data. Example operation 808 represents outputting authentication response data indicative of whether the current user is the authorized user of the computing device.

Evaluating the distribution pattern data and the baseline profile data can be performed using a trained model that was trained on at least part of the prior interaction pattern data of the authorized user.

Processing the current user interaction pattern data into the current distribution pattern data can result in Gaussian distribution pattern data representative of the current user interaction pattern data within a defined time span; the current distribution pattern data can include at least one of: mean data representative of at least one mean corresponding to the interaction by the current user, standard deviation data representative of at least one standard deviation corresponding to the interaction by the current user, occurrence data representative of at least one occurrence associated with the interaction by the current user, or probability density data representative of at least one probability density corresponding to the interaction by the current user.

The current distribution pattern data can be based on feature data corresponding to one or more active times of the interaction of the current user with the computing device, within the time span, that satisfy defined high activity threshold data; the feature data can include at least one of: active time span data representative of the one or more active times, total active time data representative of a sum of the one or more active times, a number representative of a count of the one or more active times.

The authentication response data can include binary decision data indicative of whether the current user is the authorized user of the computing device or is an unauthorized user of the computing device. The binary decision data can indicate that the current user is the unauthorized user of the computing device, and further operations can include at least one of: taking an action to authenticate a user identity associated with the current user, and/or outputting a security alert, e.g., to an administrator and/or another deice of the authorized user.

The authentication response data can include confidence level data representative of a likelihood that the current user is authorized to use the computing device, and further operations can include determining, based on whether the confidence level data satisfies defined confidence threshold data, whether the current user is the authorized user of the computing device or is an unauthorized user of the computing device. If the confidence level data does not satisfy the defined confidence threshold data, and further operations can include at least one of: taking an action to authenticate a user identity associated with the current user, or outputting a security alert.

The current user interaction pattern data can be representative of at least one of: keyboard interaction by the current user with a keyboard, pointing device interaction by the current user with a pointing device, resting by the current user, or attending a meeting by the current user.

The wearable metasurface can be incorporated into a ring designed to be worn on a finger of the current user.

The current user interaction pattern data can be representative of input device interaction by the current user with an input device, and the input device can include at least one: of a pointing device or a keyboard.

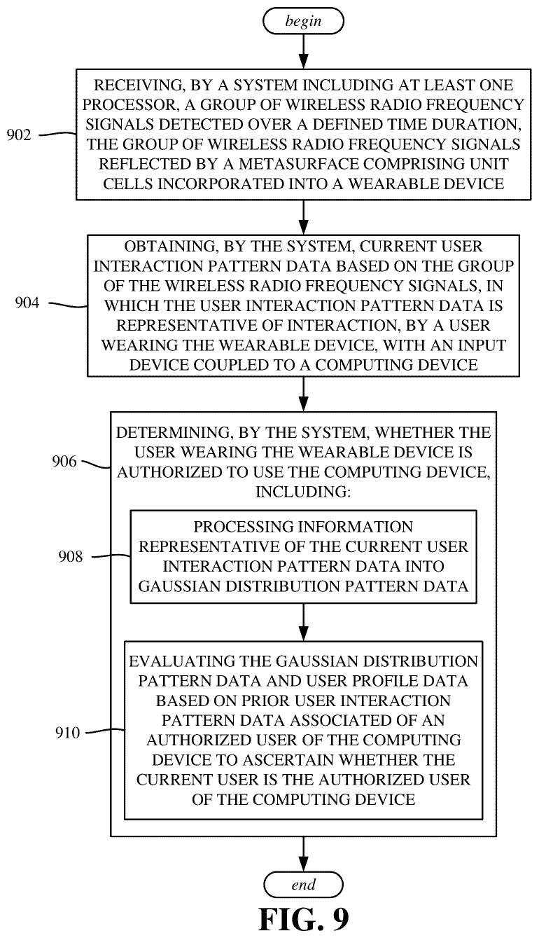

One or more example embodiments and/or implementations, such as corresponding to example operations of a method, can be represented in FIG. 9. Example operation 902 represents receiving, by a system comprising at least one processor, a group of wireless radio frequency signals detected over a defined time duration, the group of wireless radio frequency signals reflected by a metasurface comprising unit cells incorporated into a wearable device. Example operation 904 represents obtaining, by the system, current user interaction pattern data based on the group of the wireless radio frequency signals, in which the user interaction pattern data can be representative of interaction, by a user wearing the wearable device, with an input device coupled to a computing device. Example operation 906 represents determining, by the system, whether the user wearing the wearable device is authorized to use the computing device, which can include example operations 908 and 910. Example operation 908 represents processing information representative of the current user interaction pattern data into Gaussian distribution pattern data. Example operation 910 represents evaluating the Gaussian distribution pattern data and user profile data based on prior user interaction pattern data associated of an authorized user of the computing device to ascertain whether the current user is the authorized user of the computing device.

Processing the information representative of the current user interaction pattern data into the Gaussian distribution pattern data can include inputting the current user interaction pattern data into a trained model set that generates the Gaussian distribution pattern data.

Evaluating the Gaussian distribution pattern data can include inputting the Gaussian distribution pattern data into a trained model set that can be trained at least in part based on prior user interaction pattern data corresponding to the user profile data.

Determining whether the user wearing the wearable device can be authorized to use the computing device can include determining, from at least some of the wireless radio frequency signals of the group, that the metasurface corresponds to a recognized wearable device.

Further operations can include obtaining, by the system, decision data representative of whether the current user is authorized to use the computing device, or is not authorized to use the computing device, determining, by the system based on the decision data, that the current user is not authorized to use the computing device, and, in response to the determining that the current user is not authorized to use the computing device, taking at least one action, by the system, to authenticate a user identity associated with the user, or to output a security alert.

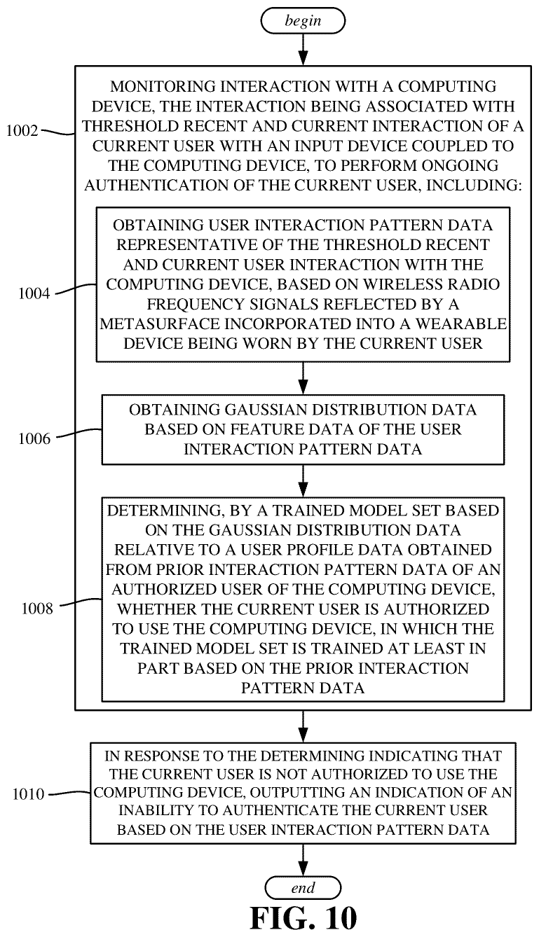

FIG. 10 summarizes various example operations, e.g., corresponding to a machine-readable medium, including executable instructions that, when executed by a processor of a target cluster, facilitate performance of operations. Example operation 1002 represents monitoring interaction with a computing device, the interaction being associated with threshold recent and current interaction of a current user with an input device coupled to the computing device, to perform ongoing authentication of the current user. Monitoring can include example operations 1004, 1006 and 1008. Example operation 1004 represents obtaining user interaction pattern data representative of the threshold recent and current user interaction with the computing device, based on wireless radio frequency signals reflected by a metasurface incorporated into a wearable device being worn by the current user. Example operation 1006 represents obtaining Gaussian distribution data based on feature data of the user interaction pattern data. Example operation 1008 represents determining, by a trained model set based on the Gaussian distribution data relative to a user profile data obtained from prior interaction pattern data of an authorized user of the computing device, whether the current user is authorized to use the computing device, in which the trained model set can be trained at least in part based on the prior interaction pattern data. Example operation 1010 represents, in response to the determining indicating that the current user is not authorized to use the computing device, outputting an indication of an inability to authenticate the current user based on the user interaction pattern data.

Further operations can include obtaining the indication of the inability to authenticate the current user, and, in response to the obtaining of the indication, taking an action based on the current user being potentially not authorized to use the computing device. Taking the action can include at least one of: outputting a security alert, or taking an action to separately authenticate a user identity associated with the current user.

Obtaining the Gaussian distribution data based on the feature data of the user interaction pattern data can be performed by the trained model set.

As can be seen, the technology described herein includes a trained model set that statistically evaluates user computing device interaction behavior with respect to prior baseline profile data collected for an authorized user of the computing device. The technology leverages a passive wearable metasurface to enable virtually continuous, non-intrusive user authentication by detecting and verifying unique interaction patterns without requiring explicit user input. The data from the passive metasurface is processed into statistical Gaussian distribution data, providing a context-aware security approach.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
at least one processor; and
at least one memory that stores executable instructions that, when executed by the at least one processor, facilitate performance of operations, the operations comprising:
obtaining current user interaction pattern data representative of interaction by a current user with a computing device via an input device, comprising:
transmitting wireless radio frequency signals; and
receiving, via a receiver coupled to the input device, reflected instances of the wireless radio frequency signals,
wherein the reflected instances of the wireless radio frequency signals are reflected by unit cells of a wearable metasurface worn by the current user, and
wherein the reflected instances of the wireless radio frequency signals are obtained over a defined time duration and are representative of the user interaction pattern data;
obtaining baseline profile data of an authorized user of the computing device based on prior user interaction pattern data of the authorized user of the computing device;
processing the current user interaction pattern data into current distribution pattern data;
evaluating the distribution pattern data and the baseline profile data to determine whether the current user is the authorized user of the computing device based on whether the current user distribution pattern data corresponds to the baseline profile data; and
outputting authentication response data indicative of whether the current user is the authorized user of the computing device.

2. The system of claim 1, wherein the evaluating of the distribution pattern data and the baseline profile data is performed using a trained model that was trained on at least part of the prior interaction pattern data of the authorized user.

3. The system of claim 1, wherein the processing of the current user interaction pattern data into the current distribution pattern data results in Gaussian distribution pattern data representative of the current user interaction pattern data within a defined time span, and wherein the current distribution pattern data comprises at least one of: mean data representative of at least one mean corresponding to the interaction by the current user, standard deviation data representative of at least one standard deviation corresponding to the interaction by the current user, occurrence data representative of at least one occurrence associated with the interaction by the current user, or probability density data representative of at least one probability density corresponding to the interaction by the current user.

4. The system of claim 3, wherein the current distribution pattern data is based on feature data corresponding to one or more active times of the interaction of the current user with the computing device, within the time span, that satisfy defined high activity threshold data, the feature data comprising at least one of: active time span data representative of the one or more active times, total active time data representative of a sum of the one or more active times, a number representative of a count of the one or more active times.

5. The system of claim 1, wherein the authentication response data comprises binary decision data indicative of whether the current user is the authorized user of the computing device or is an unauthorized user of the computing device.

6. The system of claim 5, wherein the binary decision data indicates that the current user is the unauthorized user of the computing device, and wherein the operations further comprise at least one of: taking an action to authenticate a user identity associated with the current user, or outputting a security alert.

7. The system of claim 1, wherein the authentication response data comprises confidence level data representative of a likelihood that the current user is authorized to use the computing device, and wherein the operations further comprise determining, based on whether the confidence level data satisfies defined confidence threshold data, whether the current user is the authorized user of the computing device or is an unauthorized user of the computing device.

8. The system of claim 7, wherein the confidence level data does not satisfy the defined confidence threshold data, and wherein the operations further comprise at least one of: taking an action to authenticate a user identity associated with the current user, or outputting a security alert.

9. The system of claim 1, wherein the current user interaction pattern data is representative of at least one of: keyboard interaction by the current user with a keyboard, pointing device interaction by the current user with a pointing device, resting by the current user, or attending a meeting by the current user.

10. The system of claim 1, wherein the wearable metasurface is incorporated into a ring designed to be worn on a finger of the current user.

11. The system of claim 1, wherein the current user interaction pattern data is representative of input device interaction by the current user with an input device, and wherein the input device comprises at least one: of a pointing device or a keyboard.

12. A method, comprising:
receiving, by a system comprising at least one processor, a group of wireless radio frequency signals detected over a defined time duration, the group of wireless radio frequency signals reflected by a metasurface comprising unit cells incorporated into a wearable device;
obtaining, by the system, current user interaction pattern data based on the group of the wireless radio frequency signals, wherein the user interaction pattern data is representative of interaction, by a user wearing the wearable device, with an input device coupled to a computing device; and
determining, by the system, whether the user wearing the wearable device is authorized to use the computing device, comprising:
processing information representative of the current user interaction pattern data into Gaussian distribution pattern data,
evaluating the Gaussian distribution pattern data and user profile data based on prior user interaction pattern data associated of an authorized user of the computing device to ascertain whether the current user is the authorized user of the computing device.

13. The method of claim 12, wherein the processing of the information representative of the current user interaction pattern data into the Gaussian distribution pattern data comprises inputting the current user interaction pattern data into a trained model set that generates the Gaussian distribution pattern data.

14. The method of claim 12, wherein the evaluating the Gaussian distribution pattern data comprises inputting the Gaussian distribution pattern data into a trained model set that is trained at least in part based on prior user interaction pattern data corresponding to the user profile data.

15. The method of claim 14, wherein the determining of whether the user wearing the wearable device is authorized to use the computing device comprises determining, from at least some of the wireless radio frequency signals of the group, that the metasurface corresponds to a recognized wearable device.

16. The method of claim 14, further comprising obtaining, by the system, decision data representative of whether the current user is authorized to use the computing device, or is not authorized to use the computing device, determining, by the system based on the decision data, that the current user is not authorized to use the computing device, and, in response to the determining that the current user is not authorized to use the computing device, taking at least one action, by the system, to authenticate a user identity associated with the user, or to output a security alert.

17. A non-transitory machine-readable medium, comprising executable instructions that, when executed by at least one processor, facilitate performance of operations, the operations comprising:
monitoring interaction with a computing device, the interaction being associated with threshold recent and current interaction of a current user with an input device coupled to the computing device, to perform ongoing authentication of the current user, comprising:
obtaining user interaction pattern data representative of the threshold recent and current user interaction with the computing device, based on wireless radio frequency signals reflected by a metasurface incorporated into a wearable device being worn by the current user,
obtaining Gaussian distribution data based on feature data of the user interaction pattern data, and
determining, by a trained model set based on the Gaussian distribution data relative to a user profile data obtained from prior interaction pattern data of an authorized user of the computing device, whether the current user is authorized to use the computing device, wherein the trained model set is trained at least in part based on the prior interaction pattern data; and
in response to the determining indicating that the current user is not authorized to use the computing device, outputting an indication of an inability to authenticate the current user based on the user interaction pattern data.

18. The non-transitory machine-readable medium of claim 17, wherein the operations further comprise obtaining the indication of the inability to authenticate the current user, and, in response to the obtaining of the indication, taking an action based on the current user being potentially not authorized to use the computing device.

19. The non-transitory machine-readable medium of claim 18, wherein the taking of the action comprises at least one of: outputting a security alert, or taking an action to separately authenticate a user identity associated with the current user.

20. The non-transitory machine-readable medium of claim 17, wherein the obtaining of the Gaussian distribution data based on the feature data of the user interaction pattern data is performed by the trained model set.
